(19) United States
(12) Patent Application Publication
(10) Pub. No.: US 2011/0153847 A1
(43) Pub. Date: Jun. 23, 2011

(54) COMMUNICATION NODE IN COMBINED NODE SYSTEM AND COMMUNICATION METHOD THEREOF

(75) Inventors: Bup Joong KIM, Daejeon (KR); Ji Wook YOUN, Daejeon (KR); Hong Ju KIM, Daejeon (KR); Jea Hoon YU, Daejeon (KR)

(73) Assignee: ELECTRONICS AND TELECOMMUNICATIONS RESEARCH INSTITUTE, Daejeon (KR)

(21) Appl. No.: 12/905,195

(22) Filed: Oct. 15, 2010

(30) Foreign Application Priority Data
Dec. 18, 2009 (KR) 10-2009-0127087

(51) Int. Cl. G06F 15/16

(52) U.S. Cl. 709/228

(57) ABSTRACT

A communication method of a first communication node of a combined node system including a plurality of communication nodes includes receiving data from at least one second communication node of the plurality of communication nodes, generating common control information by using the data, the common control information including data transmission path information between the plurality of communication nodes and an external communication apparatus which is on the outside of the combined node system, transmitting the common control information to the at least one second communication node, and communicating with the external communication apparatus through at least a part of the plurality of communication nodes on the basis of the common control information.

### CROSS-REFERENCE TO RELATED APPLICATION

This application claims priority to and the benefit of Korean Patent Application No. 10-2009-0127087 filed in the Korean Intellectual Property Office on Dec. 18, 2009, the entire contents of which are incorporated herein by reference.

### BACKGROUND OF THE INVENTION

(a) Field of the Invention

The present invention relates to a communication node in a combined node system and a communication method thereof.

(b) Description of the Related Art

Development of data communication has made Internet become a necessary element in everyday life. Communication equipment for supporting data communication may perform roles in a physical layer or a logical layer.

Recently, in order to improve performance and save cost, there are attempts to enable a piece of communication equipment to perform various roles. In order to enable a piece of communication equipment to perform various roles, existing communication equipment should be replaced with new communication equipment. At this time, replacing communication equipment may cost high. Therefore, it is required a method of enabling existing communication equipment to perform a new function as well as exiting functions without introducing new communication equipment.

Meanwhile, development of processing technology and semiconductor combined technology causes a rapid increase in processing capacity provided on CPU (central processing unit). Besides, development of memory combined technology causes a significant increase in memory capacity stored by one memory.

Therefore, there are attempts to expand communications infrastructure by adding a newly developing technique to existing communication equipment.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an operating method of a combined node system having advantages of combining and operating a plurality of communication nodes.

An embodiment of the present invention provides a communication method of a first communication node of a combined node system including a plurality of communication nodes includes receiving data from at least one second communication node of the plurality of communication nodes; generating common control information by using the data, the common control information including data transmission path information between the plurality of communication nodes and an external communication apparatus which is on the outside of the combined node system; transmitting the common control information to the at least one second communication node; and communicating with the external communication apparatus through at least a part of the plurality of communication nodes on the basis of the common control information.

The data may include status information on the at least one second communication node.

The data may include status information on the external communication apparatus which is on the outside of the combined node system.

The common control information may further include information on a resource shared by the plurality of communication nodes.

Interfaces for connecting the plurality of communication nodes and interfaces for connecting at least a part of the plurality of communication nodes and an external communication apparatus may be divided logically or physically.

Another embodiment of the present invention provides a communication method of a first communication node of a combined node system including a plurality of communication nodes, the method including: receiving common control information from at least one second communication node of the plurality of communication nodes, the common control information including information on data transmission paths between the plurality of communication nodes and an external apparatus which is on the outside of the combined node system; generating common control data to transmit data to a destination on the basis of the common control information; and transmitting the data to the destination on the basis of the common control data.

The common control data may include information on a third communication node of the plurality of communication nodes to be connected to the external communication apparatus.

The common control data may further include information on a fourth communication node of the plurality of communication nodes to relay data to the third communication node.

The communication method may further include transmitting information necessary to generate the common control information to the at least one second communication node.

The information necessary to generate the common control information may include status information on at least a part of the plurality of communication nodes or status information on the external communication apparatus.

Yet another embodiment of the present invention provides a communication node including: a processor configured to generate common control information including data transmission paths between a plurality of communication nodes of a combined node system and an external communication apparatus which is on the outside of the combined node system; and a transceiver configured to transmit the common control information to at least a part of the plurality of communication nodes and communicate with the external communication apparatus through the at least a part of the plurality of communication nodes on the basis of the common control information.

The transceiver may receive data from at least one communication node of the plurality of communication nodes and transmit the data to the processor, and the processor may generate the common control information on the basis of the data.

The common control information may include status information on at least a part of the plurality of communication nodes and status information on the external communication apparatus.

According to an exemplary embodiment of the present invention, it is possible to cover a wider local range and to provide expanded communication infrastructure having expanded interface. Further, it is possible to use existing communication equipment to provide a new service in addition to existing services.

### BRIEF DESCRIPTION OF THE DRAWINGS

FIG. 1 is a drawing illustrating a combined node system including a plurality of communication nodes according to an exemplary embodiment of the present invention;

FIG. 2 is a drawing illustrating a communication method of a combined node system according to an exemplary embodiment of the present invention;

FIG. 3 is a drawing illustrating a communication node 300 included in a combined node system according to an exemplary embodiment of the present invention; and

FIG. 4 is a drawing illustrating common control data according to an exemplary embodiment of the present invention.

### DETAILED DESCRIPTION OF THE EMBODIMENTS

In the following detailed description, only certain embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In specification, unless explicitly described to the contrary, the word “comprise” and variations such as “comprises” or “comprising”, will be understood to imply the inclusion of stated elements but not the exclusion of any other elements.

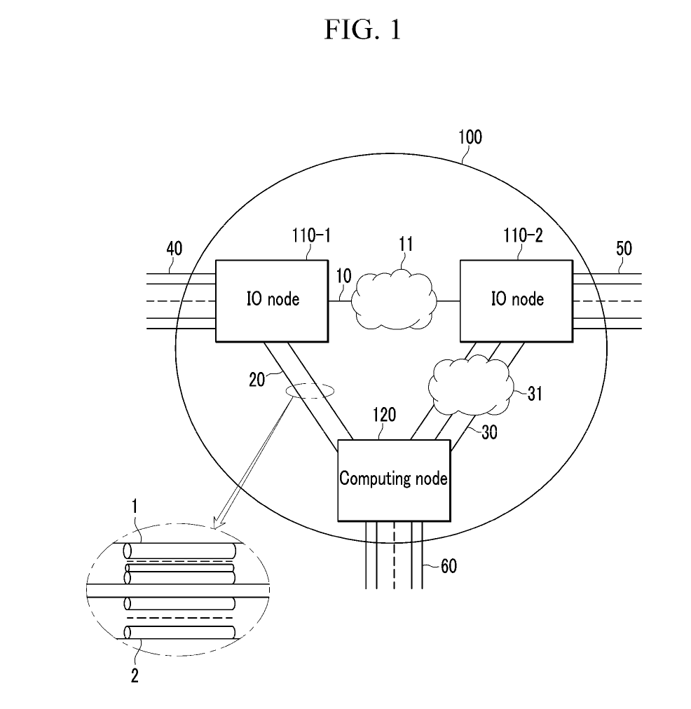

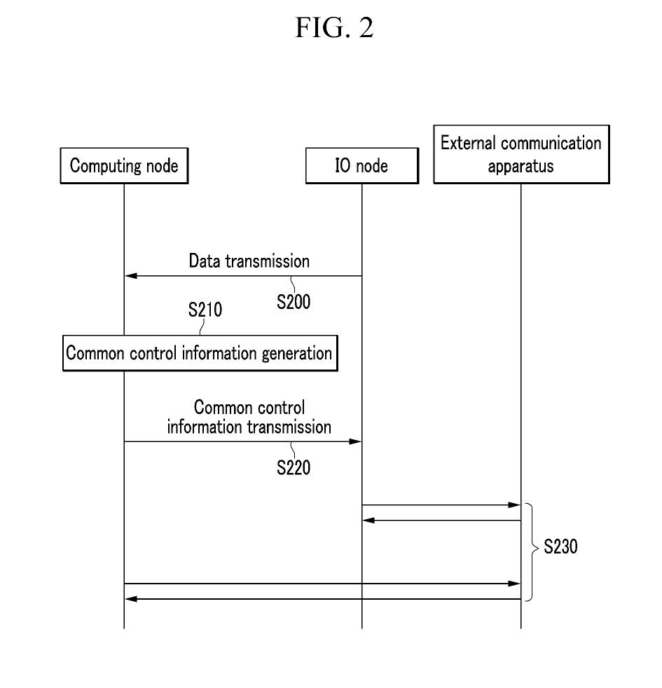

FIG. 1 is a drawing illustrating a combined node system including a plurality of communication nodes according to an exemplary embodiment of the present invention, and FIG. 2 is a drawing illustrating a communication method of a combined node system according to an exemplary embodiment of the present invention. In this specification, a communication node means an apparatus capable of performing communication and can be referred to as communication equipment, a communication apparatus, a node, etc.

Referring to FIG. 1, a combined node system 100 can operate as one combined node. The combined node system 100 includes a plurality of communication nodes 110-1, 110-2, and 120. The communication nodes 110-1, 110-2, and 120 are connected to each other by internal interfaces 10, 20, and 30, and communicate with a communication apparatus (hereinafter, referred to as an external communication apparatus), which is on the outside of the combined node system 100, by external interfaces 40, 50, and 60.

The internal interfaces 10, 20, and 30 may be connected between corresponding two of the communication nodes 110-1, 110-2, and 120 physically directly or indirectly by repeaters or relay networks 11 and 31. The individual internal interfaces 10, 20, and 30 may be divided physically or logically. For example, each of the internal interfaces 10, 20, and 30 may include a plurality of connection lines 1 and 2 distinguished physically, and each connection line may include a plurality of logical paths distinguished logically. The external interfaces 40, 50, and 60 may operate, physically or logically, independently from the internal interfaces 10, 20, and 30.

The plurality of communication nodes 110-1, 110-2, and 120 include at least one input/output (IO) node (110-1, 110-2) and at least one computing node 120. The IO nodes (110-1, 110-2) and the computing node 120 are communication nodes capable of independently operating. In the combined node system 100, the IO nodes 110-1 and 110-2 can mainly perform data reception and transmission functions. In the combined node system 100, the computing node 120 can perform a computing function as well as data reception and transmission functions. The computing function may mean a data processing function including data computing and processing. The computing node 120 may further perform a memory function. In FIG. 1, the combined node system 100 including the IO nodes 110-1 and 110-2 and the computing node 120 is shown as an example: however, the combined node system 100 may further include a memory node capable of performing a memory function as well as data reception and transmission functions.

Referring to FIGS. 1 and 2, the IO nodes 110-1 and 110-2 transmit data to the computing node 120 through the internal interfaces 10, 20, and 30 (S200). Data may be classified on the basis of a significance level, a kind, a necessary bandwidth, and a degree of urgency in processing, and the classified data may be transmitted through the connection lines 1 and 2 or through the logical paths logically distinguished in one connection line, for example, the connection line 1. Data transmitted to the computing node 120 through the internal interfaces 10, 20 and 30 may include status information on the individual communication nodes in the combined node system 100 and status information on the external communication apparatus.

The computing node 120 processes the data, received from the IO nodes 110-1 and 110-2, and generates common control information (S210). The common control information is information which is necessary for the IO nodes 110-1 and 110-2 and the computing node 120 to operate as one combined node and shared by the IO nodes 110-1 and 110-2 and the computing node 120. For example, the common control information may include data transmission path information and resource information. The data transmission path information is information on data transmission paths between the external communication apparatus and the communication nodes 110-1, 110-2, and 120 included in the combined node system 100. The data transmission path information may be information on data transmission paths between the communication nodes 110-1, 110-2, and 120 of the combined node system 100. The resource information is information on a frequency resource or a time resource shared by the plurality of communication nodes included in the combined node system 100.

The computing node 120 transmits the generated common control information to the IO nodes 110-1 and 110-2 through the internal interfaces 10, 20 and 30 (S220). As a result, the IO nodes 110-1 and 110-2 and the computing node 120 included in the combined node system 100 may share the common control information and operate as one combined node.

Each of the IO nodes 110-1 and 110-2 and the computing node 120 communicates with an external communication apparatus through a corresponding one of the external interfaces 40, 50, and 60 on the basis of the common control information (S230).

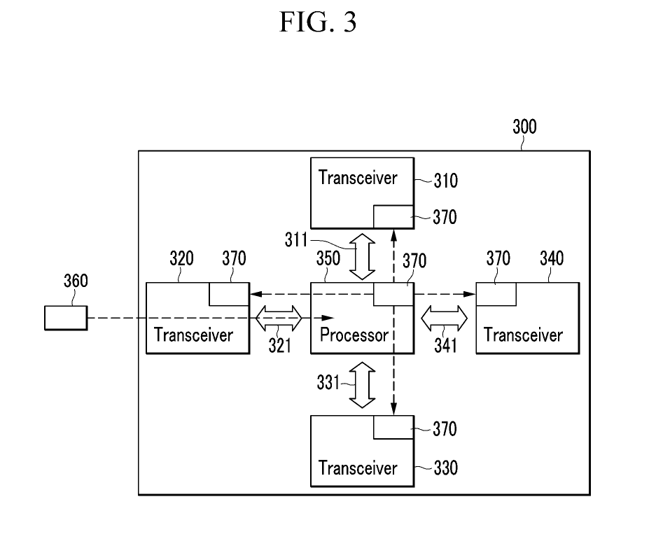

FIG. 3 is a drawing illustrating a communication node 300 included in a combined node system according to an exemplary embodiment of the present invention.

Referring to FIG. 3, a communication node 300 may be any one of the IO nodes 110-1 and 110-2 and the computing node 120. The communication node 300 includes at least one transceiver and at least one processor. For example, the communication node 300 may include four transceivers 310, 320, 330, and 340 and one processor 350, as shown in FIG. 3. The transceivers 310, 320, 330, and 340 and the processor 350 are capable of operating physically or logically, independently. The transceivers 310, 320, 330, and 340 are connected to the processor 350 by internal paths 311, 321, 331, and 341, respectively, and the transceivers 310, 320, 330, and 340 performs data communication with different communication nodes.

When the communication node 300 is the IO node 110-1 or 110-2, any one of the transceivers 310, 320, 330, and 340 receives the common control information 360 directly from the computing node 120 or indirectly from the computing node 120 through another IO node, and transmits the common control information 360 to the processor 350. The processor 350 processes the common control information 360 received from any one of the transceivers 310, 320, 330, and 340 to generate common control data 370, and transmits the generated common control data 370 to the transceivers 310, 320, 330, and 340. The common control data generated by each communication node includes information on data communication paths through which the corresponding communication node communicates with another communication node in the combined node system 100 or an external communication apparatus. Meanwhile, when there is a change inside the communication node 300 or an external communication apparatus communicating with the communication node 300, the processor 350 may generate data including the change and transmits the data to another communication node included in the combined node system, for example, the computing node 120.

When the communication node 300 is the computing node 120, the transceivers 310, 320, 330, and 340 receive data 360 from another communication node in the combined node system, for example, the IO nodes 110-1 and 110-2. Here, the data may be data including a change inside or outside the combined node system. The transceivers 310, 320, 330, and 340 transmit the received data to the processor 350, and the processor 350 uses the received data to generate common control information 370. The processor 350 may transmit the generated common control information 370 to other communication nodes in the combined node system through the transceivers 310, 320, 330, and 340.

Meanwhile, when the destination of the common control information or data received by the communication node 300 is another communication node in the combined node system, the common control information or data may be transmitted to any one of the transceivers 310, 320, 330, and 340 connected to the destination directly or by relay of the processor 350, on the basis of the common control data stored in the communication node 300.

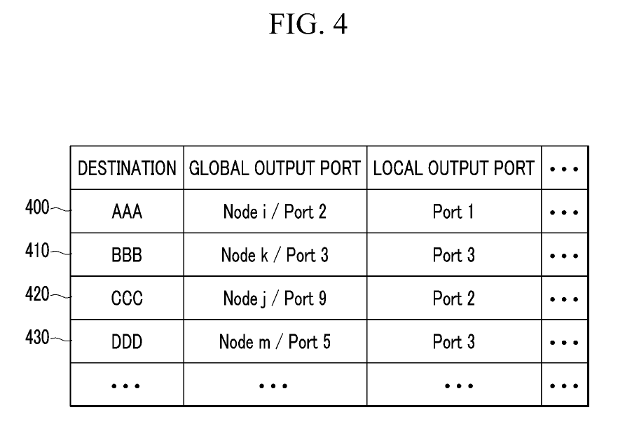

FIG. 4 is a drawing illustrating common control data according to an exemplary embodiment of the present invention.

Referring to FIG. 4, each of the individual communication nodes 110-1, 110-2, and 120 of the combined node system 100 stores a data transmission table as the common control data. The processor 350 of each of the communication nodes 110-1, 110-2, and 120 generates its own data transmission table by using the common control information 360. The data transmission table is data necessary for a communication node in the combined node system to communicate with another communication node in the combined node system or an external communication node, and includes information on which transceiver of which communication node will be used to transmit data, input to the combined node system, to the destination. Here, ports indicate the transceivers 310, 320, 330, and 340. Port numbers may be assigned to every communication node, or assigned to all ports in the combined node system.

The data transmission table may include a destination column, a global output port column, and a local output port column. The destination column includes information on the destination to which the data will be finally transmitted. The destination may be a communication node in the combined node system or an external communication apparatus. The global output port column includes information on a communication node in the combined node system and a transceiver to be used to transmit the data to the destination. The communication node in the global output port column is a communication node connected to an external communication apparatus. The local output port column includes information on a communication node in the combined node system and a transceiver to be used to transmit the data to the destination. The communication node in the local output port column is a communication node to be connected to the communication node of the combined node system.

The data transmission table includes at least one destination/global output port/local output port mapping line (for examples, reference numerals 400, 410, 420, and 430 in FIG. 4). When receiving data from an external communication apparatus, a communication node in the combined node system may transmit the data to the destination on the basis of the destination, the global output port, and the local output port in the data transmission table. The data transmission table may be used for data transmission between the communication nodes in the combined node system.

The structure and form of data transmission table are not limited thereto. The data transmission table may further include a column including added information.

In order to expand communication infrastructure and a service provision range, more communication nodes and interfaces are required. However, there is a limit to the number of communication nodes and interfaces. If a plurality of communication nodes are classified into IO nodes for mainly performing an IO function and computing nodes for mainly performing a computing function, and operates as one combined system, it is possible to achieve effects such as expansion of communication infrastructure and introduction of new services by existing communication nodes. Further, if computing nodes are replaced with communication apparatuses having been rapidly developing, it is possible to remarkably improve the performance of the combined node system.

The above-mentioned exemplary embodiments of the present invention are not embodied only by an apparatus and method. Alternatively, the above-mentioned exemplary embodiments may be embodied by a program performing functions, which correspond to the configuration of the exemplary embodiments of the present invention, or a recording medium on which the program is recorded.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A communication method of a first communication node of a combined node system including a plurality of communication nodes, the method comprising:
receiving data from at least one second communication node of the plurality of communication nodes;
generating common control information by using the data, the common control information including data transmission path information between the plurality of communication nodes and an external communication apparatus which is on the outside of the combined node system;
transmitting the common control information to the at least one second communication node; and
communicating with the external communication apparatus through at least a part of the plurality of communication nodes on the basis of the common control information.

2. The communication method of claim 1, wherein:
the data include status information on the at least one second communication node.

3. The communication method of claim 1, wherein:
the data include status information on the external communication apparatus which is on the outside of the combined node system.

4. The communication method of claim 1, wherein:
the common control information further includes information on a resource shared by the plurality of communication nodes.

5. The communication method of claim 1, wherein:
interfaces for connecting the plurality of communication nodes and interfaces for connecting at least a part of the plurality of communication nodes and an external communication apparatus are divided logically or physically.

6. A communication method of a first communication node of a combined node system including a plurality of communication nodes, the method comprising:
receiving common control information from at least one second communication node of the plurality of communication nodes, the common control information including information on data transmission paths between the plurality of communication nodes and an external communication apparatus which is on the outside of the combined node system;
generating common control data to transmit data to a destination on the basis of the common control information; and
transmitting the data to the destination on the basis of the common control data.

7. The communication method of claim 6, wherein:
the common control data include information on a third communication node of the plurality of communication nodes to be connected to the external communication apparatus.

8. The communication method of claim 7, wherein:
the common control data further include information on a fourth communication node of the plurality of communication nodes, the data being transmitted to the third communication node through the fourth communication node.

9. The communication method of claim 6, further comprising:
transmitting information necessary to generate the common control information to the at least one second communication node.

10. The communication method of claim 9, wherein:
the information necessary to generate the common control information includes status information on at least a part of the plurality of communication nodes or status information on the external communication apparatus.

11. A communication node comprising:
a processor configured to generate common control information including data transmission paths between a plurality of communication nodes of a combined node system and an external communication apparatus which is on the outside of the combined node system; and
a transceiver configured to transmit the common control information to at least a part of the plurality of communication nodes and communicate with the external communication apparatus through the at least a part of the plurality of communication nodes on the basis of the common control information.

12. The communication node of claim 11, wherein:
the transceiver receives data from at least one communication node of the plurality of communication nodes and transmits the data to the processor, and
the processor generates the common control information on the basis of the data.

13. The communication node of claim 11, wherein:
the common control information includes status information on at least a part of the plurality of communication nodes and status information on the external communication apparatus.
